(19) United States
(12) Patent Application Publication
(10) Pub. No.: US 2011/0198300 A1
(43) Pub. Date: Aug. 18, 2011

(54) DEVICE AND PROCESS FOR REMOVING MICROBIAL IMPURITIES IN WATER BASED LIQUIDS AS WELL AS THE USE OF THE DEVICE

(75) Inventors: Jannik Sadolin, Broenshoej (DK); Karim Lindberg, Veksoe (DK); Poul Fogh, Albertslund (DK)

(73) Assignee: ADEPT WATER TECHNOLOGIES A/S, Kgs. Lyngby (DK)

(21) Appl. No.: 13/120,644

(22) PCT Filed: Sep. 30, 2009
(86) PCT No.: PCT/DK2009/000215

§ 371 Date: Mar. 23, 2011

Related U.S. Application Data
(60) Provisional application No. 61/101,183, filed on Sep. 30, 2008.
(60) Provisional application No. 61/109,515, filed on Oct. 30, 2008.

(30) Foreign Application Priority Data
Sep. 30, 2008 (EP) 08017174.7
Oct. 30, 2008 (EP) 08018954.1

(51) Int. Cl. C02F 1/467; C02F 1/76; C25B 11/03; C25B 15/02

(52) U.S. Cl. 210/748.2; 205/758; 204/278.5; 204/276; 204/230.2

(57) ABSTRACT

The present invention relates to the technical filed of electrochemical elimination or reduction of microbial impurities of liquids. The liquids treated may inter alia include wastewater, industrial process water and water intended for human consumption. The device comprises a disinfection chamber connected through a liquid inlet located in the bottom of a base area by a manifold; an inner chamber housing an electrode stack comprising at least two perforated electrode plates made of conductive material symmetrically placed at a distance of 1-5 mm connected in parallel via connector mounted at the chamber; said electrode plates being separated from each other and the chamber wall at a fixed distance by spacers, and arranged such that in perpendicular plane view 60-100% of the area of passage is covered by the electrodes; an outer chamber; an outer shell; a liquid outlet; connectors for wiring connecting the connector and one or more external power supply units, each of the above elements being designed such that said liquid has a forward velocity of 2-50 cm/s and an initial perpendicular velocity component above 10 cm/s and wherein further the current density is above 5 mA/cm2.

### FIELD OF THE INVENTION

The present invention relates to the technical field of electrochemical elimination or reduction of microbial impurities of liquids. The liquids treated may inter alia include wastewater, industrial process water and water intended for human consumption.

### BACKGROUND OF THE INVENTION

Conventional methods of elimination or reduction of microbial impurities in liquids, such as waste water and water intended for human and animal consumption, typically include use of chemicals, biochemical treatment, sedimentation, distillation, filtration, electrochemical devices or the like.

In general, a balance between the type of microbiologic contamination and the disinfection method is sought. While it is required that all water used for human consumption or food processing has a certain low content of microorganisms, any chemical treatment—leaving chemicals in the water—would have possible side effects. Chemical treatment is often very effective and cost-efficient, but it has the potential risk of chemical residues in the water treated. Therefore there is a need for a system that ensures maximum efficiency of a given chemical.

Electrochemical water treatment devices consist of one or more pairs of anodes and cathodes that typically are arranged in order to allow liquids to pass in between. Moreover, various types of structural and compositional surfaces of the electrodes are possible in order to generate a variety of different reactions in the liquid that passes between the two electrodes. At the anode water may be oxidised to dioxygen and protons, and halides may be oxidised to their corresponding halogen, most commonly chlorine, via dimerisation of halogen radicals. At the cathode, the reduction of water results in hydrogen and hydroxide ions, while dioxygen may be reduced to hydrogen peroxide. Chlorine, chlorine radicals, hydrogen peroxide and ozone all have a biocidal effect on the bacteria in the treated liquid.

Several problems are associated with the generation and use of chlorine in water treatment. A particular problem is due to its potential negative effects on the environment, and legal limits for the chlorine content in water intended for human and animal consumption are continuously lowered. Despite these problems, chlorine is amongst the most effective and used disinfectants, but it is realised that any inventions capable of improving the disinfection efficiency of chlorine would be highly useful.

An example of the undesirable environmental effects of the use of chlorine is that it can react with nitrogen compounds resulting in chloramines, which are poor biocides with unpleasant odours. Furthermore, chlorine can react with organic materials, which may eventually result in environmentally harmful, possibly carcinogenic and/or teratogenic compounds such as chloroform or chloroalkanes. Also reaction with naturally occurring phenolic compounds can lead to chlorinated compounds. In wastewater treatment, chlorination must be followed by a process of laborious and potentially noxious dechlorination using sulphur dioxide or an equivalent chemical thereof in order to comply with discharge chlorine levels.

Therefore, in recent years the use of chlorine has decreased. For example, the German drinking water directive (based on EU Council Directive 98/83/EC of November 1998 on the quality of water intended for human consumption) limits the presence of chlorine in drinking water to 0.5 mg/l. Additionally, in large parts of the food industry high concentrations of chlorine in water that come into direct contact with food products are also prohibited. Usually water of “drinking quality” is considered acceptable in that context and generally water of this quality is specified for use in many processes in e.g. food factories. Traditional chlorination methods are often incapable of providing adequate disinfection capability at these concentrations, so in order to provide the desired reduction of the number of bacteria capable of creating colonies, including pathogenic bacteria in the water, it is often necessary to use concentrations of chlorine that are markedly higher than the limit allowed for drinking water. In the European Hygienic Engineering and Design Group guidelines “Safe and Hygienic Water Treatment in Food Factories” it is stated that levels of chlorine up to 1000 mg/l can be required to control bacteria, i.e. maintaining the number of bacteria below the colony-forming level. This obviously complicates even further the utilization of chlorine in water cleansing systems.

Electrochemical treatment offers an advantage because the biocides can be generated and controlled on-site, and in the case of this particular invention—in-situ. However, a major problem with electrochemical cleansing of e.g. waste water and water intended for human and animal consumption, has been the economically unfavourable energy requirements of the cleansing systems. In recent years considerable efforts to reduce the energy costs of said systems, e.g. via optimisation of the electrodes utilized, have been made. A major obstacle has been the low efficiency of the electrolysis systems in generating enough disinfectant to disinfect the water in-situ.

The efficiency of chlorine as a biocide—whether it is generated on-site or added as a chemical—is dependent on the pH of the water treated, with lower pH values being more favourable. A system that ensures locally low pH during treatment is considered an advantage regarding an increase in the efficiency for disinfection of the chlorine. Such a system will allow a reduction of the total chlorine concentration needed for effective disinfection.

Electrochemical treatment of water has been used for several years (C. E. Smith: “Waste Water Treatment through Electrochemistry” in Process in Water Technology (W. W. Eckenfelder & L. K Cecil (eds.)) Pergamon, New York 1972). The technology has been exploited since then and the understanding of the processes here in are now well established as described in the publications listed below:

A. KRAFT et al. (Journal of Applied Electrochemistry 29: 861-868, 1999), “Electrochemical water disinfection, Part I, Hypochlorite production from very dilute chloride solutions”

This article describes the first experiments on using electrolysis directly in freshwater applications using several electrode materials, and demonstrating variance with temperature and chloride concentration.

A. KRAFT et al. (Journal of Applied Electrochemistry 29: 895-902, 1999) “Electrochemical water disinfection, Part II, Hypochlorite production from potable water, chlorine consumption and the problem of calcareous deposits”

This article describes a system with several (up to 12) electrodes from either solid or expanded metal arranged in a reactor for treating water flows. While no efficiency regarding microbial removal is reported, problems with calcite deposits are mentioned, and a problem of a foreign object short-circuiting the entire reactor can be foreseen. Another problem foreseen with the publicized design is that the electrodes are limited in size. Being made of metal, and so thin that they are flexible, there is a risk of the electrodes bending and hence touching each other, causing a short circuit.

Also, the inner diameter of the reactor of 50 mm as compared to the characteristic electrode dimension of about 30 mm leaves a considerable volume in which the water can bypass the intended treatment.

EP0515628A describes a device for sterilising water by means of anodic oxidation, with one or more reactors each containing two or more electrode plates that the water must pass under laminar flow conditions.

U.S. Pat. No. 5,439,576 describes a system in which the laminar flow is a key factor in obtaining the high disinfection efficiency claimed.

EP0711730A1 describes a device suitable for treating water containing a very small amount of chlorine ions. However, the electrodes used in the device do not comprise perforations and the disclosed device cannot fulfil the flow velocities prescribed by the present invention.

The present invention comprises a method of disinfecting water without adding chemicals to the water. Also, by design, the invention maximises the efficiency of chlorine as a disinfectant. The system disclosed allows treatment of water contaminated with bacteria—but otherwise of a quality accepted for human consumption—without increasing the concentration of free chlorine above the level generally accepted by most countries as the limit for drinking water (0.5 mg/l).

The present invention offers several benefits over prior art. A major advantage is that all water is treated with high efficiency because the chamber design ensures that all water is in contact with several electrodes of different polarity—and hence is subjected to changes in pH but also changes in biocide components. This allows less biocide for the same kill effect. Another advantage of the present invention is the high biocidal effect obtained in liquids with low chloride concentrations—as encountered in drinking water systems, thus effectively disinfecting drinking water without purchase, storage and handling of chemicals.

Another advantage is the protection against a total stop of disinfection in case of a local short circuit between two electrodes. By arranging the electrode in pairs in a parallel manner, and fitting each pair with a fuse, any short circuit will only affect a small part of the electrode stack, thus increasing the operational efficiency of the system.

Further the device of the present invention takes advantage of an in-situ calcite-removing filter. The filter is installed in the downstream section of the reaction chamber and withholds particulates of brucite and/or calcite.

### SUMMARY OF THE INVENTION

The present invention comprises a process for electrochemical reduction of microbial content in-situ in liquids wherein said liquid having a forward velocity of 2-50 cm/s and an initial perpendicular velocity component above 10 cm/s is contained in an inner chamber; said inner chamber housing one or more pair(s) of parallel and symmetrically arranged perforated electrode plates with a distance of 1-5 mm, each pair fitted with a fuse; said plates being made of conductive material and arranged such, that in a perpendicular plane view, 60-100% of the area of passage is covered by the electrode stack; wherein further the current density is above 5 mA/cm². The process is particularly effective when the electrode stack covers more than 80% of the area of passage.

The present invention further comprises a device suitable for treatment of liquid according to the prescribed process and further comprises use of said device for electrochemical reduction of microbial content in-situ of various liquids.

In the case of the specific liquid media being water, the present invention offers a large increase in performance per amount of disinfectant generated. The increase in performance is due to the design of the device; further, electrical connections and means for regulation of disinfectant production are provided.

### DESCRIPTION OF THE INVENTION

The invention comprises a method of maximising the efficiency of chlorination. The system disclosed allows treatment of water contaminated with bacteria—but otherwise of a quality accepted for human consumption—without increasing the concentration of free chlorine above the level generally accepted by most countries as the limit for drinking water (0.5 mg/l).

A key factor in the present invention is the fact that all water reaches volumes with low pH near the anodes during passage of the reactor system. The volumes with low pH exhibits relatively higher concentrations of hypochlorous acid as encountered from the chlorine/hypochlorous acid/hypochlorite chemical equilibria.

An important step was found to be to ensure that all water comes into contact with the anodes during treatment. This requires some sort of turbulence or mixing, where the natural bubble formation caused by the gasses evolved is an important promoter. The arrangement of electrodes with perforated and deflective surfaces ensures a large degree of natural convection, thus further increasing the mixing. Further, a way of ensuring the most efficient mass transport is to minimize the stagnant layer adhering to the electrodes. The turbulent flow will also promote this.

Another important design parameter is that the entire water volume passes the chamber in which the electrodes cover the majority of the space, leaving no stagnant voids. This confinement was found to offer good reflective properties in the turbulent flow, thus sending the water back into the electrode stack after a pass. It was found, that a way of expressing this is the fraction of space occupied by the electrodes as viewed on a cross-section of the chamber. This is further described in FIG. 4, where (1) is the dimension of the electrodes, and (2) is the total geometric area. It was found that the invention was particularly effective with the fractional coverage of space occupied by the electrodes as viewed on a cross-section of the chamber is above 80%. Further, a particularly effective area of operation was found when the initial perpendicular velocity of the liquid upon entering the chamber was at least 1 and preferably 10 times the chamber widths per second.

Yet another important step is to allow passage through the electrode stack to ensure multiple electrode contact during the passage of the chamber, and hence maximising the time the water is in contact with acidic anodes. In order to ensure maximum convection, the electrodes are designed to include means of deflection, i.e. angled areas. Expanded metal as a basic conductor covered with a precious metal as catalyst was found to be particularly effective.

It should be noted that the value of Reynolds number is insufficient in the description of the flow status of the water. Water passing a chamber designed with perforated electrodes and gas evolution will experience a well-mixed flow profile with uniform distribution of velocities—resembling the profile of turbulent flow. A flow profile thus encountered cannot obtain the parabolic distribution of velocities characterising laminar flow.

It was found that the “state of the water during disinfection” as described above was indeed contributing to the effectiveness of the elimination of microbiological contaminants.

Distinct components of the system ensuring this flow status are described below.

The water enters the inner disinfection chamber with a forward velocity of 2-50 cm/s, such as 2-20 cm/s, such as 2-15 cm/s, such as 2-10 cm/s, such as 3-9 cm/s. The water must also have a perpendicular component. It was found that the perpendicular component scales with the size of the chamber. A particular effective flow status, in a chamber with a width of 10 cm, was obtained with a perpendicular velocity component above 10 cm/s, such as 10-500 cm/s, such as 50-450 cm/s, such as 100-400 cm/s. The above values for the perpendicular velocity component illustrates the finding that the nominal value of the perpendicular velocity should be at least 1, and preferably more than 10 times the chamber width per second.

An example of a design of this diffusor is shown in FIG. 2. The function of the diffusor is to ensure an effective distribution with respect to the direction and velocity of the incoming fluid.

When the electrodes are placed close to each other, typically, but not limited to 1-5 mm apart, such as 1.6 mm or such as 2.5 mm, the water flowing from one end of the chamber to the other was found to perform a zig-zag motion. This flow status ensures that the water reaches the anode several times during the treatment. In order to facilitate cross electrode movement, the electrodes are perforated. Perforated is here defined as a part of the macro-geometric area of the electrode being open to passage, thus allowing the liquid to move in a direction perpendicular to (across) the electrodes. In a preferred embodiment, made with expanded metal, the zig-zag motion is enhanced due to the entangled structure of the electrode plate.

For the sake of clarification in the following; a useful method for determination of the bactericidal effect comprises counting the number of bacteria colonies formed on a substrate plate after application of a predetermined volume of a water sample. The number of bacteria is then determined as the number of Colony Forming Units per water volume (CFU/ml). When the count is of a specific bacteria type, this is noted. Otherwise, in the general case, the count is referred to as Total Viable Count (TVC).

In order to ensure effectiveness of the electrochemical treatment, it is important to know the chloride content and the electrical conductivity of the liquid. By measuring these parameters a prediction of disinfectant production can be made. By measuring the water flow the dilution of the disinfectant produced can be determined. Chloride may be measured at longer intervals (i.e. months), but measurement of the conductivity is important, as a voltage controlled power supply will deliver different currents at different conductivities. Hence, a regulation of the voltage based on the values of the current and/or the conductivity (resistance) is advantageous.

### DETAILED DESCRIPTION OF THE INVENTION

### The Electrochemical Mechanisms of the Biocide Generation

The present invention comprises a process for electrochemical reduction of microbial content in-situ in liquids wherein said liquid having a forward velocity of 2-50 cm/s and an initial perpendicular velocity component above 10 cm/s is contained in an inner chamber; said inner chamber housing one or more pair(s) of parallel and symmetrically arranged perforated electrode plates with a distance of 1-5 mm, each pair fitted with a fuse; said plates being made of conductive material and arranged such, that in a perpendicular plane view, 60-100% of the area of passage is covered by the electrode stack; wherein further the current density is above 5 mA/cm². The process is particularly effective when the electrode stack covers more than 80% of the area of passage.

When the area of passage covered by the electrode stack in a perpendicular plane view, covers 60-100%, the biocidal process according to the present invention is effective. A preferred coverage is 70-100% and an even more preferred coverage is 80-100%.

In the present description and claims, “symmetrically placed” is to be interpreted such that the electrodes are placed in such a way that any single electrode offers support on one side against its neighbours, and it receives support from the two neighbouring electrodes.

Further, in one embodiment, the liquid passes a calcite-removing filter when leaving said inner chamber.

In addition a process according to the above for electrochemical reduction of microbial content in-situ in freshwater is provided where a constant rate of chlorine based oxidants is produced comprising measuring the chloride concentration and the water flow and, based on the chloride concentration and the water flow, the current through the electrodes is varied to produce and deliver a constant electrical charge in an interval of 0.015 to 0.5 Ah/l, such as a constant electrical charge in an interval of 0.015-0.4 Ah/l, such as an interval of 0.015-0.3 Ah/l, such as an interval of 0.015-0.2 Ah/l.

Chlorine based oxidants, when mentioned in the present description and claims, comprises at least, but not entirely constricted to: chlorine gas (Cl₂), hypochlorous acid (HClO) and hypochlorite (ClO⁻).

In order to ensure effectiveness of the electrochemical treatment, it is important to know the chloride content and the electrical conductivity of the liquid. By measuring these parameters a prediction of disinfectant production can be made. By measuring the water flow the dilution of the disinfectant produced can be determined. Chloride may be measured at longer intervals (i.e. months), but measurement of the conductivity with short intervals is important, as a voltage controlled power supply will deliver different currents at different conductivities. Hence, a regulation of the voltage based on the values of the current and/or the conductivity (resistance) is advantageous.

The above-mentioned processes may further comprise steps for removal of calcite deposits wherein two electrodes of the same material are chosen, and where symmetric polarity reversal (equal time for each current direction) is further applied. Alternatively, said processes for removal of calcite deposits may comprise two different materials for electrodes, where symmetric or asymmetric (unequal time for each current direction) polarity reversal is then applied.

At the anode water is oxidized electrochemically—leaving oxygen and protons. This oxygen gas is subsequently eliminated from the water through an air vent (FIG. 1 #10). The specially invented reaction-chamber of this construction leads to a rather high local concentration of protons (i.e. hydrogen ions (H⁺)) in the water thus rendering the water acidic locally near the anode. Also at the anode chloride ions (Cl⁻) naturally contained in the water donate electrons to the cathode and become chlorine gas (Cl₂). The chlorine gas dissolves in the acidic water and it is converted to hypochlorous acid (HClO) and chloride ions (Cl⁻) when the local pH is low enough.

At the cathode water is reduced—leaving hydrogen gas and hydroxyl ions. The environment of the cathode thus reaches a rather high pH. At a certain level the pH is high enough to lead to precipitation of CaCO₃ and Mg(OH)₂

The bacteria are killed when they are traversing the alternating, locally isolated regions of interchanging low and high pH, combined with the toxic effect of the oxidized chlorine species. The anode according to the present invention produces both chlorine-based and oxygen-based oxidants. The involved electrochemical and chemical reactions are outlined below.

### Oxidation of Water:

H₂O→2H⁺½O₂+2e⁻

### Electrochemical Oxidation of Chloride:

2Cl⁻→Cl₂+2e⁻

### Dissolution of Chlorine Gas, Chemical Disproportionation, Acid/Base Equilibrium Reactions:

Cl₂+H₂O→HClO+H⁺+Cl⁻

HClO [symbol] ClO⁻+H⁺

### Other Oxidation Processes:

2H₂O→H₂O₂+2H⁺2e⁻

H₂O→OH*+H⁺+e⁻

OH*→O*+H⁺+e⁻

### Reaction of Anode Activated Surface Species:

O₂+O*→O₃

2OH*→H₂O₂

### Reduction of Water:

2H₂O+2e⁻→H₂+2OH⁻

### Other Reduction Processes

O₂+2H₂O+2e⁻→H₂O₂+2OH⁻

The chlorine based oxidants formed at the anode have different biocidal strengths, where Cl₂ is most poisonous, followed by HClO and then ClO⁻ as reported in: “Handbook of Chlorination and Alternative Disinfectants”, White, C, John Wiley & Sons, New York. USA, (1999). HClO is reported to be in excess of 100 times more effective than ClO⁻. The present invention has obtained a very high killing rate for bacteria as a result of an advantageous design of the flow system described. The invented system maintains low inherent pH values at the anode thus securing a high local concentration of HClO as compared to neutral water having a pH value around 7. The arrangement of the electrodes, and the established fit of the stack in the chamber ensure that all water will pass close to an anode during the treatment—likely several times during passage of the chamber. The electrodes are perforated to ensure that the water can shift horizontally during the ascent of the chamber.

### Description of the Cleaning Chamber and its Vital Components

The present invention further comprises a disinfection device comprising a disinfection chamber, which is described in the following, and means of regulating and measuring the water flow and controls for electrical current—including fuses and power supply.

The disinfection device, which is shown in FIG. 1, is connected through a water inlet centrally located in the bottom by a mechanical arrangement (manifold/nozzles) that forces the water to dissipate evenly across the base area (#3). This may further be enhanced by inserting a diffusor to enhance the perpendicular momentum to the water, thus ensuring convection at the bottom of the chamber. An example of the design of such a diffusor is shown in FIG. 2. The manifold (FIG. 1) leads to an inner chamber (#1) housing the electrode stack comprising at least two electrodes (#2). The plastic spacers mentioned above ensure optimum contact between water and electrodes without any stagnant voids.

The water enters at the bottom of the reaction chamber and after having passed the electrodes it is forced downwards through the second, outer chamber thus leaving the reactor at the bottom. In the downward stream of water a filter material is placed, thus trapping any calcite solidified, for easy later removal.

The entire chamber construction, containing two separate areas, is contained within an outer shell (#6).

The individual electrodes are connected in parallel via a connector mounted at the top of the chamber (#7). The wiring is continued through a hole (#8) to the external power source. Air vents (#9 and #10) are placed in the same area as the electrical wiring.

The electrode stack itself is fixed at the top, where the connectors are lead outside the wet part of the chamber (#8). In order to ensure maximum flexibility of the design, and also preventing short circuits, the electrode plates (#11) are kept at a fixed distance by specially designed spacers (#12), as shown on FIG. 3. The arrangement is symmetrical, in the way that any single electrode offers support on one side against its neighbours, and it receives support from the two neighbouring electrodes.

“Diffusor” is in the present description and claims to be understood as a manifold or nozzles, which provide sufficient perpendicular momentum to the water, thus ensuring convection at the bottom of the chamber.

In case the water treated contains magnesium and/or calcium a precipitation of brucite (Mg(OH)₂) and/or calcite (CaCO₃) will occur at the cathode, as the pH increases during operation. The traditional method to prevent heavy fouling of the electrodes is to reverse the polarity of the electrodes. After current reversal the brucite and/or calcite is dissolved in the layer adjacent to the electrode—now the acidic anode. As the most inner layer is dissolved the whole precipitate will scale off from the electrode. The filter (optionally inserted at a location shown in FIG. 1#5) traps these flakes, that otherwise might hamper the hydraulic passage downstream or block valves or other equipment. The filter can be regenerated periodically by chemical treatment. If both the said anode and cathode are made of similar metals, the period each electrode is cathode or anode should be similar, therefore symmetric—in time—polarity reversal will have the optimum effect. If the electrodes are made of different materials, a non-equal or asymmetric time distribution of this polarity reversal may improve the disinfective capabilities of the system.

Thus, a preferred embodiment of the present invention comprises a device comprising a disinfection chamber (FIG. 1) connected through a liquid inlet (#3) located in the bottom of a base area by manifold/nozzles; an inner chamber (#1) housing an electrode stack comprising at least two perforated electrode plates (#2) made of conductive material symmetrically placed at a distance of 1-5 mm connected in parallel via a connector mounted at the chamber (#7); said electrode plates having an area of 300 cm² and a thickness of 1.6 mm and separated from each other and the chamber wall at a fixed distance by plastic spacers, and arranged such, that in a perpendicular plane view, at least 80% of the area of passage is covered by the electrodes (FIG. 4); optionally an outer chamber (FIG. 1 #5); an outer shell (FIG. 1 #6); a liquid outlet (FIG. 1 #4); wiring (FIG. 1 #7) connecting the connector and one or more external power supply units; air vents (FIG. 1 #9 and #10); fuses, optionally further comprising one or more of the following: impeller device, a pump-jet, or other means for recirculation.

Optionally, the device according to the present invention further comprises a calcite-removing filter placed in the outer chamber.

Optionally, the device according to the present invention further comprises a diffusor having an outlet angled from the forward direction as to introduce a perpendicular velocity.

In one embodiment of the present invention, said device comprises electrodes wherein the active electrode-material is a noble metal or alloy.

Optionally, said active electrode-material is placed on a non-corrosive conducting base material with a layer thickness of 0.1-4 microns, such as 0.5-3.5 microns, such as 1-3 microns.

Said conductive electrode base material according to the present invention may be selected from titanium, stainless steel, graphite, copper or silicon.

The anode according to WO 2007/004046 is particularly useful in the process and device according to the present invention.

Further, said electrode metal or alloy according to the present invention may be selected from platinum, iridium, ruthenium, or doped diamond or may comprise a combination thereof.

In another embodiment, said electrode has an over potential for oxygen, which is higher than the over potential for chlorine.

In a preferred embodiment of the present invention, the device further comprises a calcite-removing filter, which may be made of a plastic web or sponge structure.

In another preferred embodiment, the device according to the present invention further comprises a regulation mechanism that by measuring the electrical current and optionally the flow can maintain either a constant current, or maintain a constant energy discharge per volume of water passed.

A regulation mechanism is, in the present description and claims, to be understood as an electronic measurement of input (current) and application of suitable mathematical algorithm (PID-type) that ensures that the voltage output of the power supply unit is regulated so the current remains at the required level.

In yet another preferred embodiment, the device according to the present invention further comprises means for polarity reversal.

Means for polarity reversal is, in the present description and claims, to be understood as electrical switches and other equipment necessary to change the direction of the current running though the electrical circuit, so that the anode becomes cathode and vice versa.

### Applications of the Present Invention

The present invention can be used for several applications, where the central part is disinfection of water, the water being for industrial processes, waste, food processing or drinking water.

It was surprisingly found that the process according to claim 1 of the present invention efficiently reduces the microbial content also in water having a low chloride content of 5 mg/1-1000 mg/l.

The system can treat fresh water with chloride content below 10 mg/l, such as 9 mg/l, such as 8 mg/l, such as 6 mg/l, such as 5 mg/l and is still capable of reducing the bacterial load with a logarithmic factor 3. Higher chloride contents increase the efficiency to above log 5.

The prospect of treating water electrochemically without adding any chemicals and utilising a pH-induced boost of the disinfection efficiency of the chlorine generated offers several benefits over existing technology. This way, water can be treated without the side effects known from conventional chlorination, i.e. taste, odour, etc.

In a preferred embodiment, the device according to the present invention is used for electrochemical treatment of fresh water with chloride content above 5 mg/l and a biological activity measured as the Total Viable Count at 23 degrees centigrade above 10 CFU/ml. Thus, the method is also suitable for treating water having a low bacteria content to obtain water having a very reduced number of bacteria which is for instance used in medico industrial processes.

As shown in example 2, a total current of 50 A is adequate for treatment of drinking water infected with about 50.000 CFU/ml of E. coli to levels below the drinking water limits, i.e. below 200 CFU/ml, and still not exceeding a concentration of chlorine of 0.5 mg/l.

The present invention thus offers several benefits over prior art.

A major advantage is that all water is treated with high efficiency, because the chamber design ensures that all water is in contact with several electrodes of different polarity—and hence is subjected to changes in pH but also changes in biocide components. This allows less biocide for the same kill effect. The main advantage of the present invention is the high biocidal effect obtained in media with low chloride concentrations—as encountered in drinking water systems, thus effectively disinfecting drinking water without purchase, storage and handling of chemicals.

Another advantage is the protection against a total stop of disinfection in case of a local short circuit between two electrodes. By arranging the electrode in pairs in a parallel manner, and fitting each pair with a fuse, any short circuit will only affect a small part of the electrode stack, thus increasing the operational efficiency of the system.

In order to provide a reliable and constant disinfection rate for industrial applications, a regulation of the current can be provided, so that a given water volume has received a defined amount of electric energy, and hence a regulated amount of biocide. Depending on amongst other things the regulation area and the electrode material, the relationship may be linear or non-linear.

The biocide device as described above may further take advantage of an in-situ calcite-removing filter. The filter is installed in the downstream section of the reaction chamber, and it withholds particulates of brucite and/or calcite.

Further, the advantages of the hydraulic design ensures that there is extra room for an integrated calcite filter reducing or preventing calcite deposits downstream, and hence reducing the risk of clogging process equipment, valves or tap filters.

### BRIEF DESCRIPTION OF THE FIGURES

FIG. 1: Example of a disinfection device according to the present invention comprising a liquid inlet (#3) centrally located in the bottom by a mechanical arrangement (manifold/nozzles) that forces the water to dissipate evenly across the base area. The manifold leads to an inner chamber (#1) housing the electrode stack comprising at least two electrodes (#2). The plastic spacers (#12) ensure optimum contact between water and electrodes without any stagnant voids. The water enters at the bottom of the reaction chamber and after having passed the electrodes it is forced downwards through the second, outer chamber thus leaving the reactor at the bottom (#4). In the downward stream of water a filter material may be placed (#5), thus trapping any calcite solidified, for easy later removal.

The entire chamber construction, containing two separate areas, is contained within an outer shell (#6).

The individual electrodes are connected in parallel via a connector mounted at the top of the chamber (#7). The wiring is continued through a hole (#8) to the external power source. Air vents (#9) and (#10) are placed in the same area as the electrical wiring.

The magnification to the right shows the individual positioning of the spacers (#12). The arrangement is symmetrical, in the way that any single electrode (#11) offers support on one side against its neighbours, and it receives support from the two neighbouring electrodes.

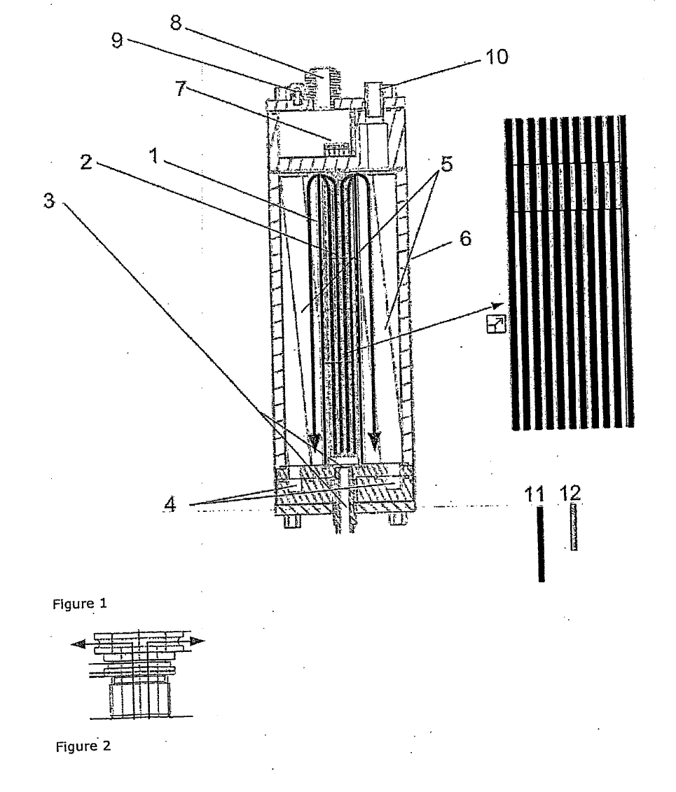

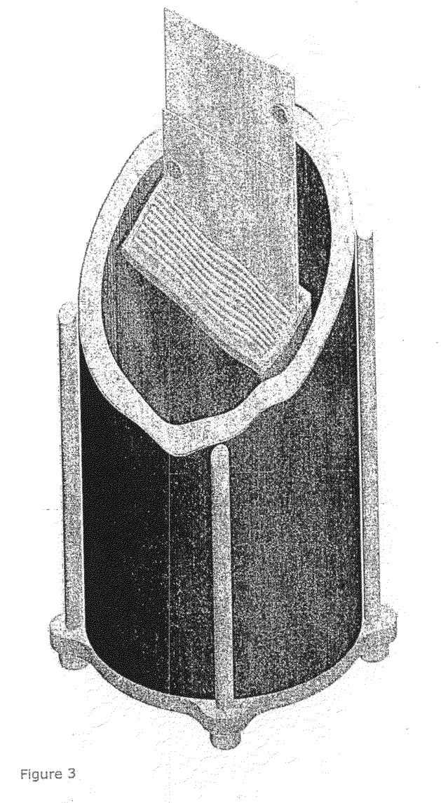

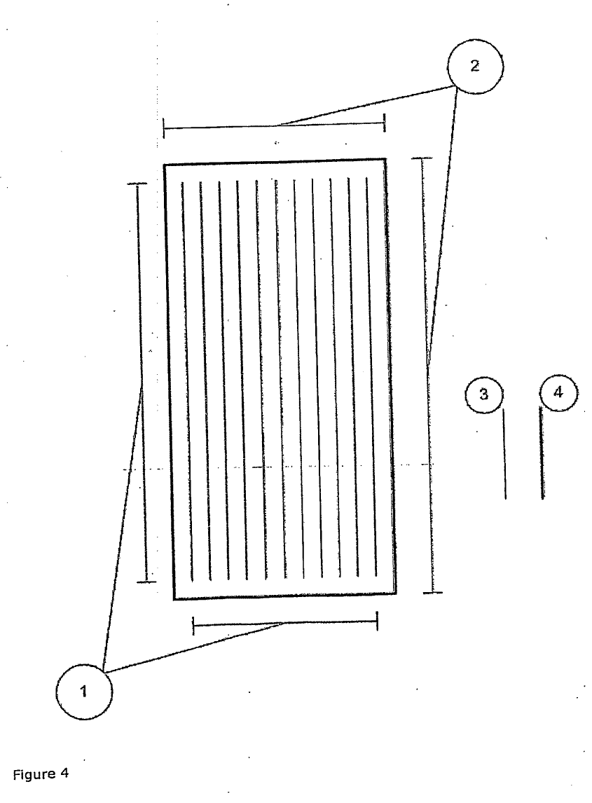

FIG. 2: Illustration of the manifold (diffusor) that forces the water to dissipate evenly across the base area of the device shown in FIG. 1. In this particular case there is one nozzle at each side, but for larger designs, several nozzles may be sensible.

FIG. 3: A 3D-view of the chamber in a cut-away, showing the plastic spacers in the electrode stack, the electrode stack, and the inner and outer chamber.

FIG. 4: Electrode plates separated from each other and the chamber wall at a fixed distance by plastic spacers (not shown), and arranged such, that in a perpendicular plane view, the electrodes cover 80% of the area of passage. The dimensions shown by marking (1) represents the macro-geometric area of the electrodes, and the dimensions shown by marking (2) represents the total area of passage. Marking (3) shows the legend for the electrode plates, and marking (4) shows the legend for the chamber wall confining the water during treatment.

### EXAMPLES

In all the examples below the chamber width is 10 cm, and the initial perpendicular velocity is thus 14-50 times the chamber width.

### Example 1

### Device According to the Present Invention

A device comprising a disinfection chamber connected through a liquid inlet located in the bottom of a base area by manifold/nozzles; an inner chamber housing an electrode stack comprising eleven perforated electrode plates. The plates were made of a base of expanded titanium, and covered with a layer of platinum 2-3 micrometers thick. The plates were perforated with approximately 50% of the macro-geometric area free.

The plates were further symmetrically placed at a distance of 1.6 mm and were connected in parallel via a connector mounted at the chamber. The electrode plates had an area of 300 cm² (width 10 cm×height 30 cm) and a thickness of 1.6 mm. The electrode plates were separated from each other and the chamber wall at the fixed distance of 1.6 mm by plastic spacers, and arranged such, that in a perpendicular plane view, the electrodes covered 80% of the area of passage. The device further comprised an outer chamber, an outer shell, a liquid outlet, wiring connecting the connector and one external power supply units; air vents and fuses.

### Example 2

### Treatment of Water Initially Comprising 50,000 CFU/ml

The device described in example 1 was used to treat drinking water which had been infected with about 50,000 CFU/ml of E. coli. The chloride concentration was measured to 12.5 mg/l. The current density was 15 mA/cm². A total current of 50 A was applied.

The volumetric flow of the treated water ranged from 400 l/h to 700 l/h with a forward velocity of 3-5 cm/s, and an initial perpendicular velocity of 140-250 cm/s.

After treatment, the water contained below 200 CFU/ml.

### Example 3

### Treatment of Water Initially Comprising 17,000 CFU/ml

The device described in example 1 was used to treat drinking water which had been infected with about 17,000 CFU/ml of E. coli. The chloride concentration was measured to 20 mg/l. The current density was 15 mA/cm². A total current of 42 A was applied.

The volumetric flow of the treated water ranged from 400 l/h to 700 l/h with a forward velocity of 5 cm/s, and an initial perpendicular velocity of 140-250 cm/s.

After treatment the water contained below 1 CFU/ml.

### Example 4

### Treatment of Water Initially Comprising 25,000 CFU/ml

The device described in example 1 was used to treat drinking water which had been infected with about 25,000 CFU/ml of E. coli. The chloride concentration was measured to 10 mg/l. The current density was 15 mA/cm². A total current of 50 A was applied.

The volumetric flow of the treated water was 1500 l/h with a forward velocity of 9 cm/s and a perpendicular velocity of 500 cm/s.

After treatment the water contained below 1 CFU/ml.

### Example 5

### Device with Large Electrode Area According to the Present Invention

A device for treatment of larger volumes of water comprising a disinfection chamber connected through a liquid inlet located in the bottom of a base area by manifold/nozzles; an inner chamber housing an electrode stack comprising twenty-two perforated electrode plates. The plates were made of a base of expanded titanium, and covered with a layer of platinum 1.5 micrometers thick. The plates were perforated with approximately 50% of the macro-geometric area free.

The plates were further symmetrically placed at a distance of 1.6 mm and were connected in parallel via a connector mounted at the chamber. The electrode plates had an area of approximately 600 cm² (width 20 cm×height 30 cm) and a thickness of 1.6 mm. The electrode plates were separated, from each other and the chamber walls at the fixed distance of 1.6 mm by plastic spacers, and arranged such, that in a perpendicular plane view, the electrodes covered 77% of the area of passage. The dimensions of the chamber are 225 by 90 mm. The device further comprised an outer chamber, an outer shell, a liquid outlet, wiring connecting the connector and one external power supply unit; air vents and fuses. The perpendicular velocity of the water was obtained by a total of four diffusers, with a total of eight nozzles. The inlet area was 15.8 cm².

### Example 6

### Treatment of Water Initially Comprising Approximately 30,000 CFU/ml

The device described in example 6 was used to treat drinking water to which had been added about 30,000 CFU/ml of E. coli.O157. The chloride concentration was measured to 20 mg/l. The current density was 30 mA/cm². A total current of 190 A was applied, giving an applied energy of 0.04-0.08 Ah/l.

The volumetric flow of the treated water ranged from 2400 l/h to 5000 l/h with a forward velocity of 3.3 to 6.9 cm/s, and an initial perpendicular velocity of 42-87 cm/s.

After treatment, the water contained below 1 CFU/ml, measured by the AGAR-plate method.

The below table shows the efficiency of the treatment at different flow rates and at different Ah/l of individual samples:

| Test Conditions: | | | | | | | | |
|---|---|---|---|---|---|---|---|---|
| Flow (l/h) | 0 | | 2415 | | 4030 | | 5039 | |
| Current (A) | 195 | | 195 | | 195 | | 195 | |
| Applied Energy (Ah/l) | | | 0.081 | | 0.048 | | 0.039 | |
| Free Chlorine measured* (mg/l) | | | 0.039 | | 0.003 | | 0 | |
| Conductivity (μS/cm) | 950 | | 950 | | 950 | | 950 | |
| | Samples: | | | | | | | |
| | Reference | | Measurement | | Measurement | | Measurement | |
| Dilution | A | B | A | B | A | B | A | B |
| 0x | | | 0 | 0 | 1 | 8 | 27 | 2 |
| 10x | | | 0 | 0 | 0 | 0 | 1 | 0 |
| 100x | 297 | 302 | 0 | 0 | 0 | 0 | 0 | 0 |
| 1000x | 45 | 31 | 0 | 0 | 0 | 0 | 0 | 0 |
| Average count (CFU/ml) | 37350 | 30600 | | | 1 | 8 | 37 | 2 |
| Average kill rate (%) | | | | >99.99 | | 99.99 | | 99.94 |

*The free chlorine content was measured with a Hach Lange DR 2800 photometer.

### Example 7

### Treatment of Water Initially Comprising Approximately 30,000 CFU/ml at High Flow Rates

The device described in example 6 was used to treat drinking water to which had been added about 30,000 CFU/ml of E. coli.O157. The chloride concentration was measured to 200 mg/l. The current density was 30 mA/cm². A total current of 190 A was applied. The energy applied to the water was 0.015 Ah/l.

The volumetric flow of the treated water was 12,700 l/h with a forward velocity of 17.4 cm/s, and an initial perpendicular velocity of 222 cm/s.

After treatment, the water contained below 1 CFU/ml, measured by AGAR-plate method. The below table shows the efficiency of the treatment:

| Test Conditions: | | | | |
|---|---|---|---|---|
| Flow (l/h) | 0 | | 12700 | |
| Current (A) | 0 | | 190 | |
| Free Chlorine measured* (mg/l) | — | | 0.104 | |
| Conductivity (μS/cm) | 1050 | | 1050 | |
| Applied Energy (Ah/l) | 0 | | 0.015 | |
| | Samples: | | | |
| | Reference | | Measurement | |
| Dilution | A | B | A | B |
| 100x | 285 | 257 | 0 | 0 |
| 1000x | 30 | 34 | 0 | 0 |
| Average count (CFU/ml) | 29250 | 29850 | <1 | <1 |

| | |
|---|---|
| Average kill rate (%) | >99.99 |

*The free chlorine content was measured with a Hach Lange DR 2800 photometer.

### Example 8

### Treatment of Water Initially Comprising Approximately 30,000 CFU/ml, with Varying Current Density

The device described in example 6 was used to treat drinking water to which had been added about 30,000 CFU/ml of E. coli.O157. The chloride concentration was measured to 60 mg/l. The current density was 7.5-30 mA/cm². A total current of 50-200 A was applied. The energy applied to the water was from 0.02 to 0.083 Ah/l.

The volumetric flow of the treated water was 2400 l/h with a forward velocity of 3.3 cm/s, and an initial perpendicular velocity of 42 cm/s.

The bacterial level varied with the energy applied, but when the energy applied was above 0.04 Ah/l, the water contained less than 1 CFU/ml.

The below table shows the efficiency of the treatment at different current of individual samples:

| Test Conditions: | | | | | | | | | | |
|---|---|---|---|---|---|---|---|---|---|---|
| Flow (l/h) | 2415 | | 2415 | | 2415 | | 2415 | | 2415 | |
| Current (A) | 0 | | 50 | | 98.5 | | 149 | | 200 | |
| Applied Energy (AM) | | | 0.021 | | 0.041 | | 0.061 | | 0.083 | |
| Free Chlorine measured* (mg/l) | | | 0.113/0.006 | | 0.03 | | 0.087 | | 0.12 | |
| Conductivity (μS/cm) | 590 | | 590 | | 590 | | 590 | | | |
| | Samples: | | | | | | | | | |
| | Reference | | Measurement | | Measurement | | Measurement | | Measurement | |
| Dilution | A | B | A | B | A | B | A | B | A | B |
| 0x | | | | | 3 | 3 | 0 | 0 | 0 | 0 |
| 10x | | | | | 53 | 0 | 0 | 0 | 0 | 0 |
| 100x | 337 | 309 | 66 | 168 | 3 | 0 | 0 | 0 | 0 | 0 |
| 1000x | 34 | 30 | 6 | 16 | 0 | 0 | 0 | 0 | 0 | 0 |
| Average count (CFU/ml) | 33850 | 30450 | 6300 | 16400 | 833 | 3 | — | — | — | — |
| Average kill rate (%) | | | | 64.7 | | 98.7 | | >99.9 | | >99.9 |

*The free chlorine content was measured with a Hach Lange DR 2800 photometer.

### Example 9

### In-Situ Reduction of Microbial Content in Freshwater

A process for electrochemical reduction of microbial content in-situ in freshwater was carried out. Initially, the chloride content was measured. The water flow was measured every 1 second and ranged from 680 l/h to 720 l/h. The current necessary to produce and deliver a constant electrical charge of 0.07 Ah/l water was applied, calculated according to the following formula:

Current (A)=Flow (l/h)×constant electrical charge (Ah/l)

### Example

Current=700 l/h×0.07 Ah/l=49 A

In order to ensure effectiveness of the electrochemical treatment, it is important to know the chloride content and the electrical conductivity of the liquid. By measuring these parameters a prediction of disinfectant production can be made. By measuring the water flow the dilution of the disinfectant produced can be determined. Chloride may be measured at longer intervals (i.e. months), but measurement of the conductivity with short intervals is important, as a voltage controlled power supply will deliver different currents at different conductivities. Hence, a regulation of the voltage based on the values of the current and/or the conductivity (resistance) is advantageous.

1-17. (canceled)

18. A process for electrochemical reduction of microbial content in-situ in liquids comprising the steps of:
treating the liquid electrochemically wherein said liquid having a forward velocity of 2-50 cm/s and an initial perpendicular velocity component of at least 1 time the chamber width per second is contained in an inner chamber; said inner chamber housing one or more pair(s) of parallel and symmetrically arranged perforated electrode plates with a distance of 1-5 mm, each pair fitted with a fuse; the arrangement of the electrodes and the established fit of the stack ensuring that all liquid will pass close to an anode during the treatment and the perforated electrodes ensuring that the liquid shifts horizontally during the ascent of the chamber; said plates being made of conductive material and arranged such that in a perpendicular plane view 60-100% of the area of passage is covered by the electrodes; wherein further the current density is above 5 mA/cm² and
determining the chloride content and the electrical conductivity of the liquid before the electrochemical treatment.

19. The process according to claim 18, wherein said perpendicular velocity component of the liquid is more than 10 times the chamber width per second.

20. The process according to claim 18 or 19 wherein said area of the passage covered by the electrodes is 70-100%.

21. The process according to claim 18, wherein said liquid further passes a calcite-removing filter when leaving said inner chamber.

22. The process according to claim 18 for electrochemical reduction of microbial content in-situ in freshwater where a constant rate of chlorine based oxidants is produced comprising measuring the chloride concentration and the water flow and, based on the chloride concentration and the water flow, the current through the electrodes is varied to produce and deliver a constant electrical charge in an interval of 0.015 to 0.5 Ah/1 water.

23. The process according to claim 18 further comprising steps for removal of calcite deposits wherein symmetric polarity reversal or asymmetric polarity reversal is further applied.

24. A device for electrochemical reduction of microbial content in-situ in liquids comprising a disinfection chamber connected through a liquid inlet located in the bottom of a base area by a manifold; an inner chamber housing an electrode stack comprising at least two perforated electrode plates placed vertically, said perforations ensuring that the liquid shifts horizontally during the ascent of the chamber, said electrode plates being made of conductive material symmetrically placed at a distance of 1-5 mm connected in parallel via a connector mounted at the chamber; said electrode plates being separated from each other and the chamber wall at a fixed distance by spacers, and arranged such that in a perpendicular plane view 60-100% of the area of passage is covered by the electrodes; an outer chamber; an outer shell; a liquid outlet; connectors for wiring connecting the connector and one or more external power supply units; each of the above elements being designed such that said liquid enters with a forward velocity of 2-50 cm/s and the design of said manifold ensuring that said liquid has an initial perpendicular velocity component of at least 1 time the chamber width per second; and wherein further the current density is above 5 mA/cm².

25. The device according to claim 24 comprising a disinfection chamber connected through a liquid inlet located in the bottom of a base area by a manifold; an inner chamber housing an electrode stack comprising at least two perforated electrode plates made of conductive material symmetrically placed at a distance of 1-5 mm connected in parallel via a connector mounted at the chamber; said electrode plates having an area of at least 300 cm² and a thickness of 1.6 mm and separated from each other and the chamber wall at a fixed distance by plastic spacers, and arranged such that in a perpendicular plane view 70-100% of the area of passage is covered by the electrodes; an outer chamber; an outer shell; a liquid outlet; connectors for wiring connecting the connector and one or more external power supply units; air vents; fuses, optionally further comprising one or more of the following: impeller device, a pump-jet or other means for recirculation.

26. The device according to claim 24 or 25 further comprising a calcite-removing filter placed in the outer chamber.

27. The device according to claim 24, wherein the active electrode-material is a noble metal or alloy.

28. The device according to claim 27, wherein said active material is placed on a non-corrosive conducting base material with a layer thickness of 1-4 micrometers.

29. The device according to claim 27, wherein said conductive base material is selected from titanium, stainless steel, graphite, copper or silicon.

30. The device according to claim 27, wherein said metal or alloy is selected from platinum, iridium, ruthenium, or doped diamond, or a combination thereof.

31. The device according to claim 26, wherein said calcite-removing filter is made of a plastic web or sponge structure.

32. The device according to claim 24, further comprising a regulation mechanism that by measuring the electrical current and optionally the flow can maintain either a constant current, or maintain a constant energy discharge per volume of water passed.

33. The device according to claim 24, further comprising means for polarity reversal.

34. A method for electrochemical treatment of fresh water with chloride content above 5 mg/l and a biological activity measured as the Total Viable Count at 23 degrees centigrade above 10/ml which comprises contacting the water with a device according to claim 24.
